(19) United States
(12) Patent Application Publication
(10) Pub. No.: US 2005/0005800 A1
(43) Pub. Date: Jan. 13, 2005

(54) Method and apparatus for applying an ink image to a receiving material

(76) Inventors: Andreas C. Stoot, Venlo (NL); Eduard T. H. De Grijs, Venlo (NL)

Correspondence Address: BIRCH STEWART KOLASCH & BIRCH, PO BOX 747, FALLS CHURCH, VA, 22040-0747, US

(21) Appl. No.: 10/874,364

(22) Filed: Jun. 24, 2004

(30) Foreign Application Priority Data
Jun. 27, 2003 (EP) 03077004.4

(51) Int. Cl. B41M 1/00

(52) U.S. Cl. 101/483; 427/294; 427/282

(57) ABSTRACT

An apparatus for applying an ink image to a receiving material adapted to be advanced in a specific direction which includes an ink application system for applying an ink image to a strip of receiving material, which strip extends in a direction transverse to the direction of advance of the receiving material, the ink application means being movable over the strip of receiving material, a carrier device for maintaining the strip in a predetermined position with respect to the ink application system, which carrier device includes a carrier plate for carrying the strip, said carrier plate having recesses and said carrier plate being provided with holes, a vacuum device for sucking away air via said holes from the space between the carrier plate and a strip of receiving material lying on the carrier plate, and correction means for correcting local variations in the distance between the receiving material and the ink application mean.

This non-provisional application claims priority under 35 U.S.C. § 119(a) on Patent Application No. 03077004.4 filed in Europe on Jun. 27, 2003, which is herein incorporated by reference.

### BACKGROUND OF THE INVENTION

The present invention relates to an apparatus for applying an ink image to a receiving material. More particularly the present invention relates to copiers or printers, for example, photocopiers or inkjet printers, wherein the receiving material is retained against a carrier plate. The present invention further relates to a method for applying an ink image to a receiving material.

An apparatus for maintaining a receiving material flat against a carrier plate during the application of an ink image thereto is generally known. The carrier plate is, for example, provided with V-shaped channels, which extend in the direction in which the receiving material is movable stepwise, over the carrier plate. Ribs which separate the channels from one another are provided with suction openings in order to draw bubbles, which are formed by moisture absorption in the receiving material, into the channels by vacuum pressure, in order to prevent the bubbles from coming into contact there with ink application means which are flatly movable over the carrier plate.

The receiving material is pulled against the carrier plate with considerable force so that it is possible to ensure with a great degree of certainty that parts of the receiving material, particularly bubbles extending in the direction of the ink application means, remain out of contact with the ink application means.

A disadvantage of the known apparatus is that the ink images on some receiving materials are distorted due to, for example, locally occurring line broadening and density variations in area-fills.

### SUMMARY OF THE INVENTION

An object of the present invention is to eliminate the disadvantages existing in known apparatus.

A further object of the present invention is to provide an apparatus having an improved control over the process of the application of an ink image onto a receiving material in order to, at least, reduce the distortions mentioned above.

From one aspect, the present invention provides an apparatus for applying an ink image to a receiving material adapted to be advanced in a direction of advance, comprising:
ink application means for applying an ink image to a strip of receiving material, which strip extends in a direction transverse to the direction of advance of the receiving material, wherein the ink application means are movable over the strip of receiving material,
carrier means for maintaining the strip in a predetermined position with respect to the ink application means, which carrier means includes a carrier plate for carrying the strip, said carrier plate having recesses and provided with holes,
vacuum means for sucking away air via said holes from the space between the carrier plate and a strip of receiving material lying on the carrier plate, and
correction means for correcting local variations in the distance between the receiving material and the ink application means.

Some receiving materials, particularly slack or compliant receiving materials, are pulled into the recesses to some extent due to the vacuum pressure. On the one hand this is advantageous since it reduces the extent to which bubbles extend in the direction of the ink application means. On the other hand, the sagging of the receiving material into the recesses may result in positioning errors in the ink image.

For example, in the case a line of equidistant dots is to be printed onto the receiving material, the ink image of these dots can be distorted when the line crosses a part of the receiving material that has sagged into a recess. In the direction of movement of the ink application means, the distance between the dots on the receiving material will increase when the ink application means moves over a downward slope of the sagged receiving material. This distance will decrease when the ink application means moves over an upward slope of the sagged receiving material. Since this distortion of the ink image is repeated in each strip of receiving material, these distortions add up to form a pattern in the direction of advance of the receiving material.

Moreover, the carrier plate can be provided with a series of regularly spaced recesses or channels as known in the art. As a consequence of this, the above-mentioned distortions appear around the position of each recess, so that these distortions add up to form a longitudinal wave pattern in a direction perpendicular to the direction of advance of the receiving material.

Providing the apparatus for applying an ink image to a receiving material with a correction system for at least partially correcting local variations in the distance between the receiving material and the ink application means has been found to result in a substantial improvement in the ink image due to a reduction in the misalignment of the ink dots which make up the ink image.

In a first embodiment, the correction means comprise timing means for adjusting the moment of ink release by the ink application means. Local distance variations cause variations in flight time of the ink droplets from the ink application means to the receiving material. Said variations in flight time of the ink droplets can be compensated for by adjusting the moment of ink release. For example, when the receiving material has sagged into a recess, the distance between the receiving material and the ink application means is locally enlarged and the flight time of the ink droplet will increase. Advancing the moment of ink release by the ink application means can compensate for this increased flight time and can correct the misalignment of the position of the ink droplet due to the sagging of the receiving material into the recess.

In a further development, the timing means are arranged for advancing the moment of ink release when the ink application means is near a downward slope of a recess, and for delaying the moment of ink release when the ink application means is near an upward slope of a recess. Preferably the advance and delay are defined by an undulatory electronic signal, wherein the leading and tailing edges of the undulatory signal correspond to the downward and upward slopes of the recesses, respectively. The differences in flight time can thus be corrected using a simple electronic correction of the signal that controls the moment of ink release by the ink application means.

In a further development, the ink application means are arranged for moving with uniform velocity over the carrier plate. In this case, and in combination with regularly spaced recesses on the carrier plate, the undulatory electronic signal is also regular, and a simple regular electronic wave signal can be used.

In a second embodiment, the correction means comprises speed adjustment means for adjusting the relative velocity between the ink application means and the carrier plate. In a further development, the speed adjustment means are arranged for reducing the relative velocity when the ink application means is near a downward slope of a recess, and for increasing the relative velocity when the ink application means is near an upward slope of a recess. Due to this variation in relative velocity between the ink application means and the carrier plate, the trajectories of the ink droplets can be adjusted to compensate for local distance variations between the ink application means and the receiving material.

The adjustment of the relative velocity between the ink application means and the carrier plate, can be carried out with the speed adjustment means which comprises a translation system for moving the carrier plate in a direction substantially parallel to the direction of the strip of receiving material. In a further development, the translation means are arranged for a reciprocating movement of the carrier plate. Such a translation means for moving the carrier plate has the advantage that no changes have to be made to the ink application means, and that the known ink application means can be used in the apparatus of the present invention.

Alternatively, the speed adjustment means comprises means for adjusting the velocity of the ink application means. This adjustment of the velocity of the application means may be defined by an undulatory electronic signal, wherein the leading and tailing edges of the undulatory signal correspond to the downward and upward slopes of the recesses, respectively. The variation of the velocity can thus be achieved by a simple electronic correction of a signal for controlling the velocity of the ink application means.

The above-mentioned means for adjusting the velocity of the ink application means and the translation means for moving the carrier plate in the direction substantially parallel to the direction of the strip of receiving material, can also be combined. In this case the required adjustment of the relative velocity between the ink application means and the carrier plate can be divided between the means for adjusting the velocity of the ink application means and the translation means. In this way the amount of adjustment of each of these means can be reduced. In particular, the velocity of the translation means for moving the carrier plate can be reduced.

A further advantage of the above mentioned first and second embodiments is that the distance between the carrier plate and the ink application means is not affected by the correction means. Thus the risk that the receiving material may come into contact with the ink application means is as low as in the prior art.

In a third embodiment the correction means comprises an adjustment means for locally adjusting the distance between the ink application means and the carrier plate. In a further development, this adjustment results in essentially a constant distance between the ink application means and the receiving material. This adjustment of the distance may also be defined by an undulatory electronic signal where the leading and tailing edges of the undulatory signal correspond with the downward and upward slopes of the recesses.

In a further development, the adjustment means comprises first movement means for moving the carrier plate in a direction for adjusting the distance between the ink application means and the carrier plate. The adjustment means may also, or in addition, comprise a second movement means for moving the ink application means in a direction for adjusting the distance between the ink application means and the carrier plate. In an apparatus comprising first and second movement means, the extent of adjustment can be divided between these two movement means, thereby reducing the required amount of adjustment of each of these movement means.

In a preferred embodiment the apparatus further comprises controlling means for controlling the correction means depending on of at least one of the following characteristics, i.e., receiving material characteristics, ink characteristics, ink image characteristics, print mode, carrier plate characteristics, distance between the ink application means and the carrier plate, and the velocity of the ink application means with respect to the carrier plate. Using at least one of these characteristics, the extent to which the receiving material is pulled into the recesses, can be estimated, derived or determined. The controlling means controls the correction means for correcting this estimated extent of sagging of the receiving material into the recesses. The use of such a controlling means results in a very flexible apparatus, which can easily adapt to various conditions such as, for example, various different types of receiving materials.

In a further development, the controlling means includes input means for inputting these characteristics. One or more of these characteristics or values defining the state of these characteristics may be inputted or modified via the input means when changing, for example, from one type of receiving material to another type of receiving material or from one type of printing ink to another type of printing ink. The values may be numerical values, but may also include other characters, such as alphanumeric characters.

The receiving material characteristics may include at least one of the following characteristics, including the grade, the type, the thickness, the moisture content, the weight or substance per unit area, and the sizing.

The ink characteristics may include at least one of the following characteristics, including the viscosity, the water or solvent content of the ink, and the wetting characteristics of the ink.

The ink image characteristics may include at least one of the following characteristics, including area fraction covered by ink, pixel density and the like.

The print mode may be one of a last mode, normal mode, and best mode. In the last mode, the ink image is printed in one single move of the ink application means over the strip of receiving material. In the normal mode, the ink image is printed in a reciprocating movement of the ink application means over the strip of receiving material. In the best mode, the ink image is printed in more than one forward motion or reciprocating motion.

The carrier plate characteristics may include at least one of the following characteristics, including configuration of the recesses, profile of the recesses and magnitude of the vacuum pressure generated by the vacuum means.

In a further development, the apparatus includes a detection means for detecting the positions of the recesses with respect to a path of the ink application means. The information about the relative position of the recesses with respect to the path of the application means can then be transferred to the controlling means. This information can be used for controlling the correction means as described above. The detection means can be used for the calibration or recalibration of the correction means and may, for example, be used in a start-up phase of the apparatus according to the present invention for detecting the relative positions of the recesses with respect to the actual path of the ink application means.

From a second aspect, the present invention provides a method for applying an ink image to a receiving material using an apparatus adapted to advance the receiving material in a direction of advance, wherein the method includes the steps of:
placing a strip of receiving material on a carrier means in a predetermined position with respect to an ink application means, which carrier means is a carrier plate for carrying the strip, wherein the carrier plate contains recesses extending in the direction substantially parallel to the direction of advance of the receiving material, and the carrier plate is provided with holes,
maintaining the strip of receiving material on the carrier means by using a vacuum means to draw air via said holes from the space between the carrier plate and the strip of receiving material lying on the carrier plate,
applying an ink image to the strip of receiving material using the ink application means, which strip extends in the direction transverse to the direction of advance of the receiving material, and
correcting local variations in the distance between the receiving material and the ink application means using correction means during the movement of the application means over the strip of receiving material.

The correction can be performed by adjusting the moment of ink released by the ink application means, using timing means as described above.

In addition or alternatively, the local variations can also be corrected by adjusting the relative velocity with which the ink application means is moved over the carrier plate for applying the ink image to the strip of receiving material.

Furthermore, adjusting the distance between the ink application means and the carrier plate can correct the local variations.

In a further development, the local variations in the distance between the receiving material and the ink application means are estimated or determined using at least one of many characteristics including ink characteristics, receiving material characteristics, ink image characteristics, print mode, carrier plate characteristics, distance between the ink application means and the carrier plate, and the velocity of the ink application means with respect to the carrier plate. Such characteristics may be inputted into the controlling means for controlling the correction means.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings, which are given by way of illustration only, and thus are not limitative of the present invention, and wherein:

FIG. 1 is a top perspective view of a detail of an apparatus according to the prior art;

FIG. 2 is a cross-sectional view of a detail of the carrier means;

FIGS. 3A, 3B and 3C are schematic representations of exemplary embodiments according to the present invention;

FIG. 4 is a schematic view of an electronic signal for controlling the correction means; and

FIG. 5 is a diagram of the controlling means for controlling the correction means of the present invention.

### DETAILED DESCRIPTION OF THE INVENTION

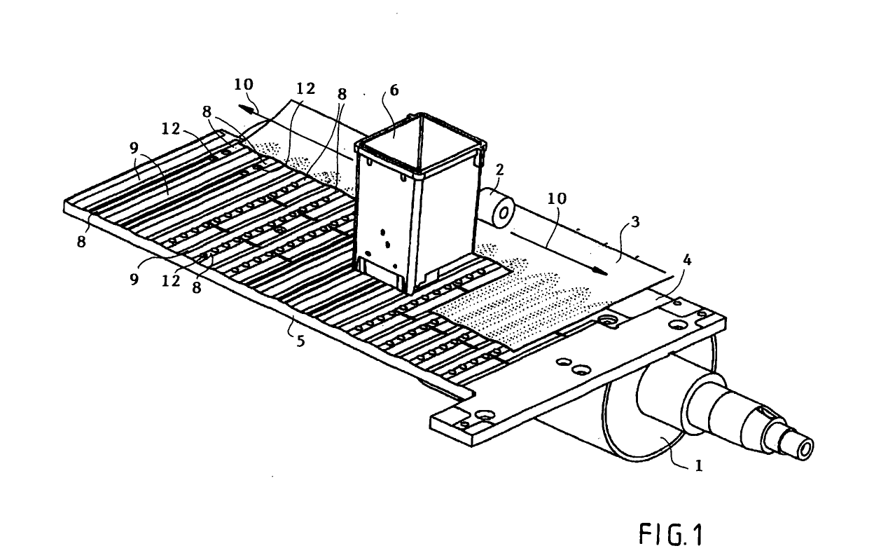

The apparatus as shown in FIG. 1 comprises a transport roller 1 with a transport nip 2 in a feed path for feeding a receiving material 3 originating from a stock (not shown). Roller system 1 is formed by a drivable roller with a diameter of about 80 mm and a number of soft rubber contact pressure rollers with a diameter of about 14 mm to provide a slip-free intermittent transport for the receiving material 3 through the in-line transport nip 2. The feed path in which the transport nip 2 is situated is formed by guide plate 4 over which the receiving material 3 moves. Guide plate 4 is followed in the transport direction by a carrier plate 5 which forms a carrying surface for a part of the receiving material 3 which is fed thereon. Printing a part of the receiving material 3 lying on the carrier plate 5 is effected by an ink application means such as an inkjet printhead 6. One or more printheads may be used for applying an ink image to the receiving material 3 in a known manner.

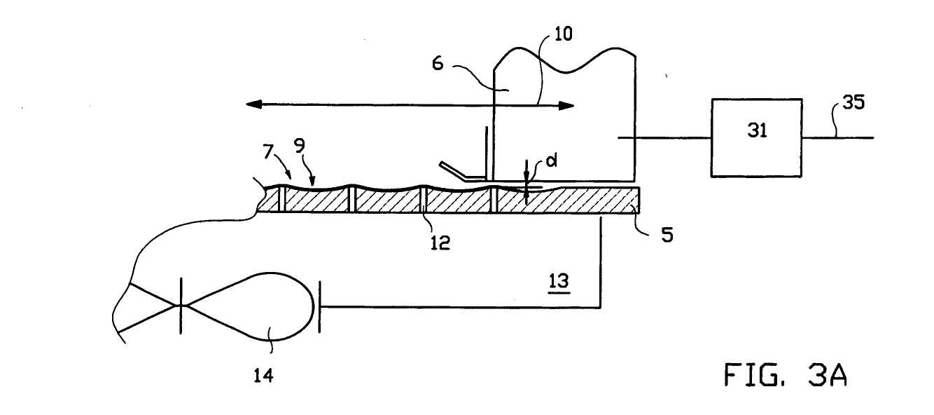

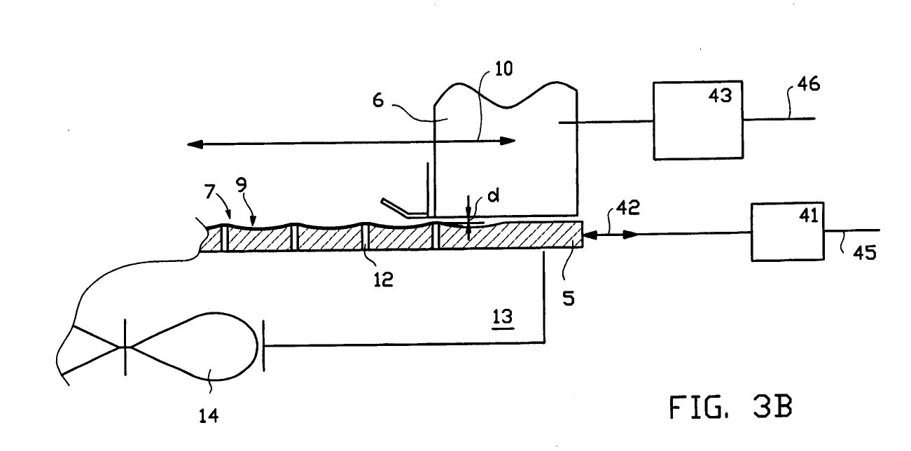

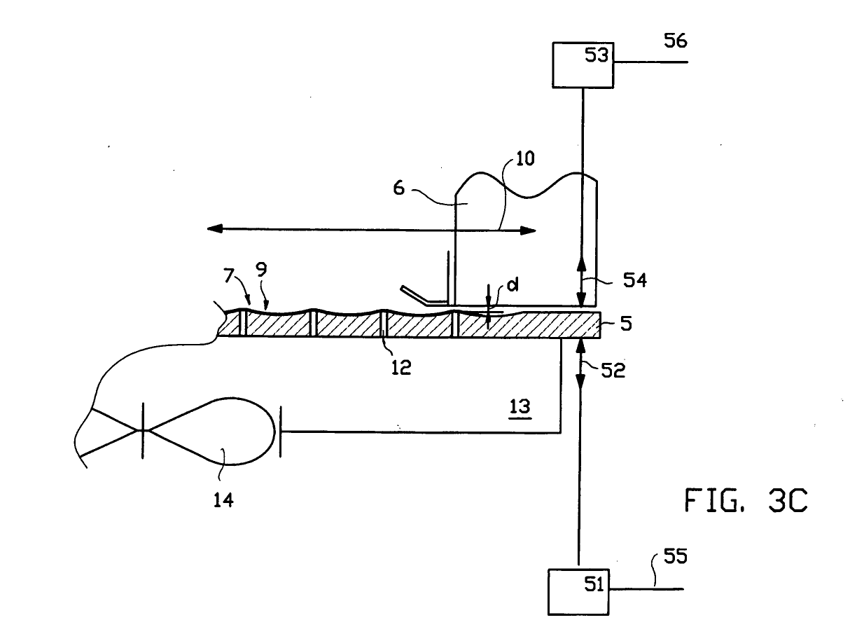

As shown in FIG. 1, the carrier plate 5 has a profiled form consisting of V-shaped ribs 7 which extend parallel to the direction of advance of the receiving material 3 over the carrier plate 5. Each rib 7 is formed by a top surface 8, and the top surface 8 lies in a plane which extends a short distance d beneath the underside of the printhead 6 (see FIGS. 3A, 3B and 3C). This distance d is herein referred to as the distance between the ink application means 6 and the carrier plate 5.

Between the ribs 7, recesses 9 are formed which serve to prevent contact between the receiving material 3 on the carrier plate 5 and the printhead 6 moving in a reciprocating motion 10 over the receiving material 3. The receiving material 3 may locally curl up, most likely due to moisture absorption during the printing with an aqueous ink in particular. Any bubbles above the channel shaped recesses 9 can sag therein.

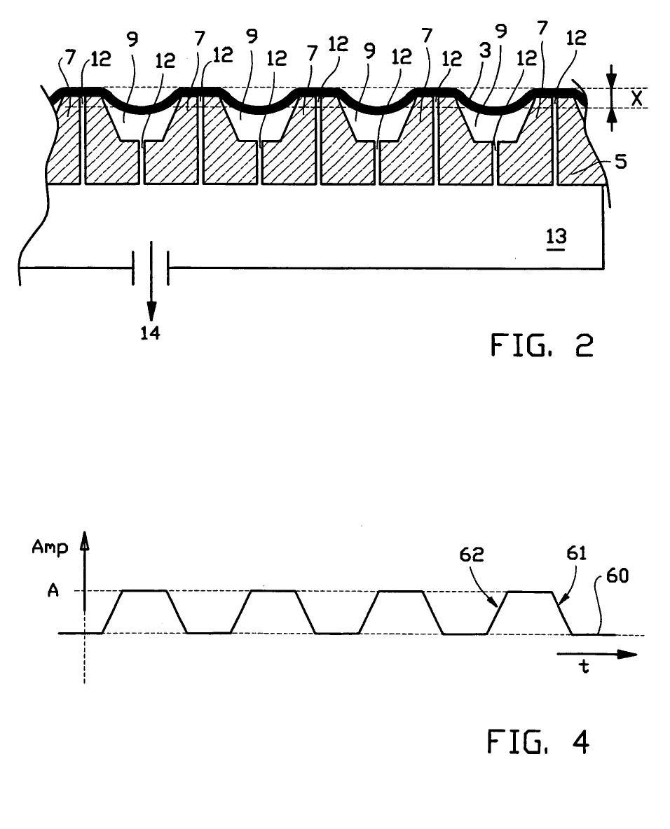

The carrier plate 5 is provided with holes 12 which are connected beneath the carrier plate 5 to an air chamber 13 which is connected to vacuum means 14 for sucking away air via the holes 12 from the space between the carrier plate 5 and the strip of receiving material 3 lying on the carrier plate 5. In FIG. 1 the holes 12 are provided in the top surface 8 of the ribs 7. However, the holes 12 may also be provided in the channels 9, as depicted in FIG. 2. Due to the vacuum pressure between the carrier plate 5 and the receiving material 3, the receiving material 3 is to some extent pulled in the channels 9 as depicted in FIG. 1. This situation is schematically depicted in the cross-sectional view of FIG. 2. Here the depth to which the receiving material 3 sags into the channels 9 is indicated by the symbol X. This depth normally is approximately 1 mm, but may be as large as 3-4 mm.

In order to, at least partially, compensate for the local variations in the distance between the ink application means 6 and the receiving material 3, the apparatus according to the present invention provides a correction means as depicted in the FIGS. 3A, 3B and 3C.

In a first exemplary embodiment as schematically depicted in FIG. 3A, the apparatus according to the present invention is provided with timing means 31 for adjusting the moment of ink release by the printhead 6 during the motion 10 of the printhead 6 over the receiving material 3 lying on the carrier plate 5.

In a second exemplary embodiment as schematically depicted in FIG. 3B, the apparatus of the present invention is provided with speed adjustment means 41, 43 for adjusting the relative velocity of the ink application means 6 with respect to the carrier plate 5. This relative velocity can be adjusted by translation means 41 which moves the carrier plate 5 in a reciprocating motion 42 in a direction substantially parallel to the direction of the motion 10 of the printhead 6 over the receiving material 3 lying on the carrier plate 5. In addition or alternatively, the relative velocity can be adjusted by speed adjustment means 43, which adjust the velocity of the printhead 6 during its motion 10 over the receiving material 3.

In a third exemplary embodiment as schematically depicted in FIG. 3C, the apparatus according to the present invention is provided with adjustment means 51, 53 for adjusting the distance d between the printhead 6 and the carrier plate 5. This distance d can be adjusted by first movement means 51 for moving the carrier plate 5 in a direction 52 substantially perpendicular to the motion 10 of the printhead 6 over the receiving material 3 lying on the carrier plate 5. In addition or alternatively, the distance d can be adjusted by second movement means 53 for moving the printhead 6 in a direction 54 substantially perpendicular to the motion 10 of the printhead 6.

The positions of the channels 9 with respect to the path of the printhead 6 during its motion 10 over the carrier plate 5 with said channels 9, and the relative velocity with which the printhead 6 moves over the strip of receiving material 3, are known or can be determined. The correction means 31, 41, 43, 51, 53 are controllable by an undulatory electronic signal 60 as depicted in FIG. 4, wherein the leading edge 61 and tailing edge 62 of the undulatory signal 60 correspond with downward and upward slopes of the channels 9 (compare with the channels 9 of FIG. 2).

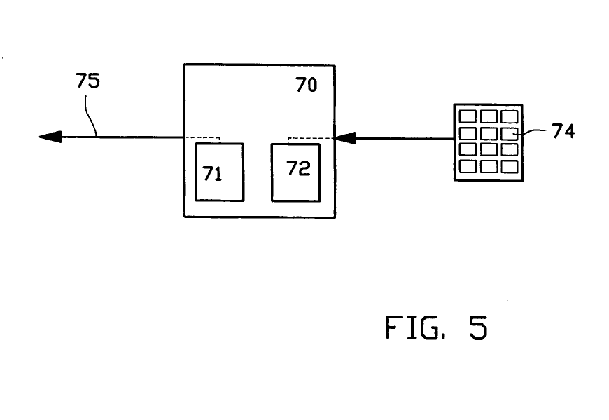

The amplitude A of the signal 60 is adjustable depending on the depth X to which the receiving material 3 sags into the channels 9. To this end, the above-mentioned exemplary embodiments of the apparatus according to the present invention can be provided with controlling means 70 as depicted in FIG. 5. The controlling means comprises a microprocessor 71 and memory 72. Characteristics of the print process are stored in the memory means 72. The particular characteristics of the print process may include: the receiving material 3, the ink characteristics, the ink image, the print mode, the carrier plate 5, the distance between the printhead 6 and the carrier plate 5, and the velocity of the printhead 6 with respect to the carrier plate 5. Coupled to the controlling means 70 is a keyboard control panel 74 for inputting or changing the characteristics in the memory 72. When, for example, the first receiving material is replaced by a second receiving material with different characteristics, the characteristics of the first receiving material as stored in the memory 72 can be replaced with the characteristics of the second receiving material.

The microprocessor 71 can determine or derive the depth X to which the receiving material 3 will sag into the channels 9 from the characteristics of the print process as stored in the memory means 72. In response to this information, the microprocessor 71 produces or adjusts the control signal, for example the amplitude Amp of the signal 60 as depicted in FIG. 4, which control signal is sent via an output 75 of the controlling means 70 to an input 35, 45, 46, 55, 56 of the correction means 31, 41, 43, 51, 53, respectively.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An apparatus for applying an ink image to a receiving material adapted to be advanced in a desired direction which comprises:
ink application means for applying an ink image to a strip of receiving material, said strip extending in a direction transverse to the direction of advance of the receiving material, wherein the ink application means is movable over the strip of receiving material,
carrier means for maintaining said strip in a predetermined position with respect to the ink application means, said carrier means including a carrier plate for carrying said strip, said carrier plate having recesses and said carrier plate being provided with holes,
vacuum means for sucking away air via said holes from the space between the carrier plate and a strip of receiving material lying on the carrier plate, and
correction means for correcting local variations in the distance between the receiving material and the ink application means.

2. The apparatus as claimed in claim 1, wherein the correction means comprise timing means for adjusting the moment the ink released by the ink application means.

3. The apparatus as claimed in claim 2, wherein the timing means are arranged for advancing the moment of ink release when the ink application means approaches a downward slope of a recess, and for delaying the moment of ink release when the ink application means approaches an upward slope of a recess.

4. The apparatus as claimed in claim 2, wherein the ink application means are arranged for moving with uniform velocity over the carrier plate.

5. The apparatus as claimed claim 1, wherein the correction means comprises speed adjustment means for adjusting the relative velocity between the ink application means and the carrier plate.

6. The apparatus as claimed in claim 5, wherein the speed adjustment means are arranged for reducing the relative velocity when the ink application means approaches a downward slope of a recess, and for increasing the relative velocity when the ink application means approaches an upward slope of a recess.

7. The apparatus as claimed in claim 5, wherein the speed adjustment means comprises a translation means for moving the carrier plate in a direction substantially parallel to the direction of the strip of receiving material.

8. The apparatus as claimed in claim 7, wherein the translation means is arranged for a reciprocating movement of the carrier plate.

9. The apparatus as claimed in claim 5, wherein the speed adjustment means comprises means for adjusting the velocity of the ink application means.

10. The apparatus as claimed in claim 1, wherein the correction means comprises adjustment means for adjusting the distance between the ink application means and the carrier plate.

11. The apparatus as claimed in claim 10, wherein the adjustment means comprise first movement means for moving the carrier plate in a direction for adjusting the distance between the ink application means and the carrier plate.

12. The apparatus as claimed in claim 11, wherein the adjustment means comprises a second movement means for moving the ink application means in a direction for adjusting the distance between the ink application means and the carrier plate.

13. The apparatus as claimed in claim 1, wherein the correction means are controllable by an undulatory electronic signal, wherein the leading and tailing edges of the undulatory signal correspond with downward and upward slopes of the recesses.

14. The apparatus as claimed in claim 1, wherein the apparatus further comprises controlling means for controlling the correction means depending on at least one of a plurality of characteristics including receiving material characteristics, ink characteristics, ink image characteristics, print mode, carrier plate characteristics, distance between the ink application means and the carrier plate, and the velocity of the ink application means with respect to the carrier plate.

15. The apparatus as claimed in claim 14, wherein the receiving material characteristics includes at least one of the grade, the type, the thickness, the moisture content, the weight or substance per unit area, and the sizing.

16. The apparatus as claimed in claim 14, wherein the ink characteristics include at least one of the viscosity and wetting characteristics of the ink.

17. The apparatus as claimed in claim 14, wherein the ink image characteristics include at least one of the characteristics selected from the group comprising the area fraction covered by ink and pixel density.

18. The apparatus as claimed in claim 14, wherein the print mode comprises at least one of the last mode, the normal mode, and the best mode.

19. The apparatus as claimed in claim 14, wherein the carrier plate characteristics comprise at least one of the configuration and/or profile of the recesses and magnitude of a vacuum pressure generated by the vacuum means,

20. The apparatus as claimed in claim 19, further comprising detection means for detecting the positions of the recesses with respect to a path of the ink application means.

21. The apparatus as claimed in claim 14, wherein the controlling means includes input means for inputting at least one of said characteristics.

22. A method for applying an ink image to a receiving material using an apparatus adapted to advance the receiving material in a desired direction which comprises:
placing a strip of receiving material on a carrier means in a predetermined position with respect to an ink application means, said carrier means comprising a carrier plate for carrying said strip, said carrier plate having recesses and said carrier plate being provided with holes,
maintaining the strip of receiving material on the carrier means by sucking away air via said holes from the space between the carrier plate and the strip of receiving material lying on the carrier plate using vacuum means,
applying an ink image to a strip of receiving material using an ink application means, said strip extending in a direction transverse to the direction of advance of the receiving material, and
correcting local variations in the distance between the receiving material and the ink application means using correction means.

23. The method as claimed in claim 22, wherein the correction means comprises timing means for adjusting the moment the ink is released.

24. The method as claimed in claim 22, wherein the correction means comprises speed adjustment means for adjusting the relative velocity between the application of ink and the carrier plate.

25. The method as claimed in claim 22, wherein the correction means comprises adjustment means for adjusting the distance between the ink application and the carrier plate.

26. The method as claimed in claim 22, wherein the correction means are controlled by an undulatory electronic signal, wherein the leading and tailing edges of the undulatory signal correspond with downward and upward slopes of the recesses.

27. The method as claimed in claim 22, wherein the correction means are controlled by controlling means for controlling the correction means depending on at least one of a plurality of characteristics including receiving material characteristics, ink characteristics, ink image characteristics, print mode, carrier plate characteristics, distance between the ink application means and the carrier plate, and the velocity of the ink application means with respect to the carrier plate.

28. An apparatus for applying an ink image to a receiving material which comprises:
ink application means for applying an ink image to a strip of receiving material,
carrier means for maintaining said strip in a predetermined position with respect to the ink application means, said carrier means including a carrier plate, containing recesses, whereby the receiving material sags into said recesses causing a variation in distance between the ink application means and the receiving material, and
correction means for correcting said variations in the distance between the ink application means and the receiving material.

29. The apparatus of claim 28 wherein the correction means is a timing means for adjusting the moment of ink release by the printhead.

30. The apparatus of claim 28 wherein the correction means is a speed adjustment means for adjusting the relative velocity of the ink application means with respect to the carrier plate.

31. The apparatus of claim 28 wherein the correction means is a means for adjusting the distance between the ink application means and the carrier plate.
